(19) United States
(12) Patent Application Publication
(10) Pub. No.: US 2025/0360503 A1
(43) Pub. Date: Nov. 27, 2025

(54) CONTROLLED RESERVOIR FILLING

(71) Applicant: NUCLERA LTD, Cambridge (GB)

(72) Inventors: Michal Jan Horka, Cambridge (GB); Sumit Kalsi, Cambridge (GB); Tobias William Barr Ost, Cambridge (GB); Andreas Michael Waeber, Cambridge (GB); Nikolaos Emmanouilidis, Cambridge (GB)

(21) Appl. No.: 18/875,007

(22) PCT Filed: Jun. 21, 2023
(86) PCT No.: PCT/GB2023/051617

§ 371 Date: Dec. 13, 2024

(30) Foreign Application Priority Data
Jun. 21, 2022 (GB) 2209109.4

(51) Int. Cl. B01L 3/00

(52) U.S. Cl. CPC B01L 3/502715; B01L 2200/0642; B01L 2200/16; B01L 2300/0829; B01L 2400/049

(57) ABSTRACT

Provided herein are methods for the controlled filling of multiple reservoirs on a microfluidic device with a defined area of fluid, the method comprising: a. providing a device with a plurality of wells connected via entry holes to a substrate bearing a plurality of electrodes; b. filling the device with an aqueous immiscible filler liquid such that the plurality of wells are at least partially filled with the filler liquid; c. loading two or more of the wells with an aqueous liquid which descends in the wells; and d. withdrawing a portion of the filler liquid from the device, thereby drawing the aqueous liquids onto the plurality of electrodes through the entry holes in order to form multiple differently sized volumes of aqueous liquid.

### FIELD OF THE INVENTION

Provided herein are methods for enabling automated bubble free loading of an aqueous phase reservoir covering more than one electrode on a microfluidic device with a defined area of fluid. This invention is in the field of fluid electrowetting-on-dielectric (EWoD) and the devices using these phenomena.

### BACKGROUND TO THE INVENTION

Microfluidic devices for manipulating droplets or particles based on electrical signals have been extensively described. Electrokinesis (movement due to electrical signals) occurs as result of (1) a non-uniform electric field that influences the hydrostatic equilibrium of a dielectric liquid (dielectrophoresis or DEP) or (2) a change in the contact angle of the liquid on solid surface (electrowetting-on-dielectric or EWoD). DEP can also be used to create forces on polarizable particles to induce their movement. The electrical signal can be transmitted to a discrete electrode, a transistor, an array of transistors, or a sheet of semi-conductor film whose electrical properties can be modulated by an optical signal.

The manipulation of droplets by the application of electrical potential can be achieved on electrodes covered with an insulator or a dielectric or a series of insulators or dielectrics. Droplet manipulation as a result of an applied electrical potential is known as electrowetting. In the case of droplets in channels this can be achieved by causing the droplets, for example in the presence of an immiscible carrier fluid, to travel through a microfluidic channel defined by the walls of a cartridge or microfluidic tubing. Embedded in the walls of the cartridge or tubing are the electrodes covered with a dielectric layer each of which are connected to an electrical circuit capable of being switched on and off rapidly at intervals to modify the wetting properties of the droplet on the dielectric layer. This gives rise to the ability to steer the droplet along a given path.

In contrast to channel based microfluidics, digital microfluidics (DMF) utilizes alternating electrical signal on an electrode array for moving fluid on the surface of the array. Liquids can thus be moved on an open-plan device by electrowetting. Digital microfluidics allows precise control over the droplet operations including droplet movement, fusion, and separation.

DMF uses EWoD phenomena when droplets are actuated between two parallel electrodes (forming a cell gap) covered with a hydrophobic insulator or a dielectric. The electric field at the electrode-electrolyte interface induces a change in the surface tension, which results in droplet motion because of a change in droplet contact angle. The electrowetting effect can be quantitatively treated using Young-Lippmann equation:

cos θ−cos θ₀=(½γ_{LG})c·V²

where θ₀ is the contact angle when the electric field across the interfacial layer is zero, γ_{LG} is the liquid-gas tension, c is the specific capacitance (given as εᵣ, ε₀/t, where εᵣ is dielectric constant of the insulator/dielectric, ε₀ is permittivity of vacuum, t is thickness) and V is the applied voltage or electrical potential. The change in contact angle (inducing droplet movement) is thus a function of surface tension, electrical potential, dielectric thickness, and dielectric constant.

Planar DMF devices consist of two substrates separated by a cell gap, typically of several hundred microns. In this cell gap, an electric potential is applied to manipulate aqueous droplets by actuating electrodes to alter the surface wettability. For a real-world application, reagents/samples are to be loaded into this cell gap to form interstitial reservoirs and then smaller daughter droplets dispensed from the reservoir.

When a droplet is actuated by EWoD, there are two opposing sets of forces that act upon it: an electrowetting force induced by electric field and resistant forces that include the drag forces resulting from the interaction of the droplet with filler medium and the contact line friction. The minimum voltage applied to balance the electrowetting force with the sum of all drag forces (threshold voltage) is variably determined by the thickness-to-dielectric contact ratio of the insulator/dielectric, (t/εᵣ)^{1/2}. Thus, to reduce actuation voltage, it is required to reduce (t/εᵣ)^{1/2} (i.e., increase dielectric constant or decrease insulator/dielectric thickness). To achieve low voltage actuation, thin insulator/dielectric layers must be used. However, the deposition of high quality thin insulator/dielectric layers is a technical challenge, and these thin layers are easily damaged before the desired electrowetting contact angle is large enough to drive the droplet is achieved. Most academic studies thus report the use of much higher voltages >100V on easily fabricated, thick dielectric films (>3 μm) to effect electrowetting.

High voltage EWoD-based devices with thick dielectric films, however, have limited industrial applicability largely due to their limited droplet multiplexing capability. The use of low voltage devices including thin-film transistors (TFT) and optically-activated amorphous silicon layers (a-Si) have paved the way for the industrial adoption of EWoD-based devices due to their greater flexibility in addressing electrical signals in a highly multiplex fashion. The driving voltage for TFTs or optically-activated a-Si are low (typically <15 V). The bottleneck for fabrication and thus adoption of low voltage devices has been the technical challenge of depositing high quality, thin film insulators/dielectrics. Hence there has been a particular need for improving the fabrication and composition of thin film insulator/dielectric devices.

EWoD uses electric fields for manipulation of liquid droplets and to perform droplet operations such as movement, mixing and splitting. The droplets are usually generated from an interstitial reservoir, formed in the cell gap (defined by the spacer introduced between two electrically addressable substrates), which is metered in via a fluid applicator e.g. pipette or automated fluid delivery sub-system.

Loading of a metered area in a bubble free manner is critical. DMF devices have a low surface energy coat inside the cell gap; this together with a relatively hydrophillic plastic housing on the port makes the loading difficult. These plastic housings tend to draw the liquid back out of the EWoD to fill the plastic port instead of the interstitial reservoir in the cell gap. During the process of loading, air bubbles can easily be introduced which block the reservoir filling and affects its function. Pressurising of the liquid in order to force entry often results in the liquid being forced back out of the inlet port when the pressure is released.

There are many prior art methods of loading EWoD devices which are sub-optimal. For example US2015352544 describes a system configured to conduct designated reactions for biological or chemical analysis. The system includes a liquid-exchange assembly comprising an assay reservoir for holding a first liquid, a receiving cavity for holding a second liquid that is immiscible with respect to the first liquid, and an exchange port fluidically connecting the assay reservoir and the receiving cavity. The system also includes a pressure activator that is operably coupled to the assay reservoir of the liquid-exchange assembly. The pressure activator is configured to repeatedly exchange the first and second liquids by (a) flowing a designated volume of the first liquid through the exchange port into the receiving cavity and (b) flowing a designated volume of the second liquid through the exchange port into the assay reservoir. The system also includes a fluidic system that is in flow communication with the liquid-exchange assembly.

US2014/0008222 describes a method of using a syringe to draw liquid into a device. The method, as described for example in FIG. 9 shows that shows that liquid from a single reservoir can be drawn into a device by withdrawing the same amount of liquid from an opposing reservoir. FIG. 9 shows only a single reagent in the loading port.

GB2542372 describes a method of passive loading based on equilibration of pressure. A volume of reagent loaded into wells naturally displaces a venting fluid (air or filler fluid) from the device simply due to the hydrostatic head pressure caused by the additional loaded fluid.

US2020108396 describes a microfluidic device which comprises upper and lower spaced apart substrates defining a fluid chamber therebetween; an aperture for introducing fluid into the fluid chamber; and a fluid input structure disposed over the upper substrate and having a fluid well for receiving fluid from a fluid applicator inserted into the fluid well. The fluid well communicates with a fluid exit provided in a base of the fluid input structure, the fluid exit being adjacent the aperture. The fluid well comprises first, second and third portions, with the first portion of the well forming a reservoir for a filler fluid; and the second portion of the well being configured to engage with a good fit against an outer surface of a fluid applicator inserted into the fluid well. The third portion of the well communicates with the fluid exit and has a diameter at the interface between the third portion and the second portion that is greater than the diameter of the second portion at the interface between the third portion and the second portion.

It is therefore an object of the invention to provide an improved method for loading multiple aqueous liquid areas into EWoD devices. This invention enables loading of multiple different sized reservoirs simultaneously. This invention enables loading of multiple reservoirs simultaneously from different sides of the device. Any operation on DMF based devices, requires precise measurement of droplets and calibrations to compensate for variability in fabrication techniques. For instance, in order to accurately dispense droplets from a reservoir held on the device, accurate control of the fill area of the reservoir is needed. Reservoir volume is a function of cell gap height and the actuated area of the DMF filled during loading. The volume is therefore defined by the area, which is in turn defined by the number of actuated pixels. Variations in gap height and interactions between aqueous reagents and the loading ports makes loading a consistent area hard to achieve. Loading errors can give erroneous reservoir filling for applications where reagents are loaded at regular intervals to run cycles. For AM-EWoD (active matrix electrowetting on dielectric) DMF, the high resolution active matrix on the backplane of the TFT adds complexity to reservoir loading as the user (or an algorithm) cannot easily determine the level to which the reservoir has to be filled to. Conventional passive EWoD devices have a discrete reservoir electrode, which makes it easier to fill them by providing visual and/or electronic feedback.

Planar DMF devices consist of two substrates separated by a cell gap, typically of several hundred microns. In this cell gap, an electric potential is applied to manipulate aqueous droplets by actuating electrodes to alter the surface wettability. For a real-world application, reagents/samples are to be loaded into this cell gap to form interstitial reservoirs and then smaller daughter droplets dispensed from the reservoir. Droplets can be obtained by repeated splitting of the reservoir, or by repeated dispense operations. The success rate for dispensing daughter droplets, the dispense accuracy, and the dispense precision are all dependent on the area of the reservoir matching expectation. It is difficult to control the reservoir filling by metering an exact volume into the cell gap, with difficulties including cell gap variation that causes under fill or overfill and the hydrophobicity of Teflon™ and/or plastic housing on the DMF device giving rise to capillary forces. Such problems are especially acute for loading multiple reservoirs simultaneously.

U.S. Pat. No. 7,763,471 describes loading a fluidic device from reagents on a part of the chip outside the device, i.e. the device contains wells that are separate to the DMF.

U.S. Pat. No. 8,821,705 shows a digital microfluidics system loaded with a single pipette.

US 2011/0220505 describes a method for transferring liquid on a EWoD device using actuation alone to initiate a flow of liquid between reservoirs on the device. The actuation can be performed using multiple channels (‘toothed electrodes’). The teeth are used to move and steer the liquid.

### SUMMARY OF THE INVENTION

Provided herein is a method for the controlled filling of reservoirs on a microfluidic device. More specifically, a method for controlled filling of a reservoir on an electrowetting on dielectric (EWoD) device. More specifically, a method for loading multiple reservoirs of different volumes simultaneously without introducing air through the inlet ports.

Loading of reagents is a function of several inter-dependent processes; EWoD forces to draw (and retain) the reagents in; capillary forces to draw the reagents into the plastic port, fluctuations in the cell gap during a pressure driven load; surface tension of the reagents and the Laplace pressure defined by the shape of the reagent in the plastic port and the cell gap. Typically interior surfaces of the device are more hydrophobic than the surfaces of the loading device. The invention relates to improved method for loading multiple aqueous reagents and with a higher accuracy for the target and metered volumes. Therefore, the presented method is especially beneficial for loading reagents with high surface tension and for using plastics to design the fluid delivery housing which are usually hydrophilic.

Disclosed is a method of loading aqueous liquid into a digital microfluidic device having a substrate bearing a plurality of electrodes, the method comprising:
a. providing a device with a plurality of wells connected via entry holes to a substrate bearing a plurality of electrodes;
b. filling the device with an aqueous immiscible filler liquid such that the plurality of wells are at least partially filled with the filler liquid;
c. loading one or more of the wells with an aqueous liquid which descends in the wells; and
d. withdrawing a portion of the filler liquid from the device, thereby drawing the aqueous liquid onto the plurality of electrodes through the entry holes.

Disclosed is a method of loading multiple differently sized volumes of aqueous liquid into a digital microfluidic device having a substrate bearing a plurality of electrodes, the method comprising:
a. providing a device with a plurality of wells connected via entry holes to a substrate bearing a plurality of electrodes;
b. filling the device with an aqueous immiscible filler liquid such that the plurality of wells are at least partially filled with the filler liquid;
c. loading two or more of the wells with an aqueous liquid which descends in the wells; and
d. withdrawing a portion of the filler liquid from the device, thereby drawing the aqueous liquids onto the plurality of electrodes through the entry holes in order to form multiple differently sized volumes of aqueous liquid.

The volume of, and direction of flow of aqueous liquids introduced may be controlled using the electrodes on the substrate.

The device can be an active-matrix thin film transistor (AM-TFT) based device.

Also disclosed is an active-matrix thin film transistor (AM-TFT) device having a substrate bearing a plurality of electrodes, the device comprising multiple fluidic inlet ports on at least two sides of the device, wherein the inlet ports on each side of the device are evenly spaced and wherein the device is connected to a syringe pump.

The device may comprise two substrates, wherein at least one substrate has a plurality of electrodes, and the two substrates define parallel plates that are separated by a spacer to define a volume.

The device may be made from a bottom plate having an array of electrodes (TFT), a top plate (optionally glass although may be plastic) defining a cell gap therebetween. The top plate may contain holes for loading reagents, or the top and bottom plate may be sealed with a spacer having entry holes. The entry holes may be located underneath a housing (for example made of plastic) containing inlet loading ports to load regents into the cell gap. A device is filled with filler fluid to fill the cell gap and at least partially fill all the inlet ports. Reagents are placed into the ports using an external source, for example a multi-channel pipette. The reagent sinks to the bottom end of the port, close to the entry hole in the top glass. Filler fluid is removed from the cell gap and the reagent is introduced into the device for downstream electrowetting operations.

The device is connected such that filler fluid levels within the device can be adjusted. One or more ports are connected to a source of filler fluid. The loading process can be driven by removing filler fluid from one port or simultaneously from multiple ports. The multiple ports can be placed on the same side or on opposite sides on the device. The oil can be extracted from two corners of the device which can be on the same side or diagonal corners. Many ports on the device can be loaded simultaneously simply by removing filler fluid from the cell gap. The entry path taken by the aqueous liquid can be controlled by the electrodes on the array. Electrode activation alone is not sufficient to draw liquid from the hydrophilic ports to the hydrophobic cell gap, the flow of filler fluid from the cell gap is needed. The filler fluid should remain in the inlet ports in order to prevent ingress of air to the device through the inlet ports.

The filler liquid may be a hydrophobic or non-ionic liquid. For example the filler liquid may be decane or dodecane. The filler fluid may be a silicone oil such as dodecamethylpentasiloxane (DMPS). The filler liquid may contain a surfactant, for example a sorbitan ester such as Span 85.

The fluidic entry may come via holes in the upper plate or through the spacer. The entry holes may be in the top substrate. The plurality of electrodes may be on a bottom substrate. The top substrate be of glass or polymer and may have a thickness ranging from 0.5 mm to 20 mm.

The wells/inlet ports may be designed to avoid changes of angles to which the aqueous liquid can become trapped. Thus the sides of the wells may form a continuous curve having no inflection points. Heavier liquids introduced into the wells therefore sink to the bottom of the well regardless of the volume added to the well or the size of the well. The lack of inflection point prevent trapping of reagents and reduce the ingress of bubbles.

The spacer may comprise an adhesive with beads of a defined size distribution. The spacer may comprise a polymer material of a defined thickness. The spacer may comprise glass, in which case the layers can be fused together. The spacer gap and therefore height of fluid in the device may be between 50 microns and 250 microns. The spacer gap and therefore height of fluid in the device may be between 100 microns and 150 microns. The spacer may comprise a tape, which may be adhesive.

The filler liquid may moved via an automated manner, or may be moved under gravity. A hydrostatic head of pressure can be used to move the liquid within the device. The wells are at least partially filled with filler fluid before the aqueous reagents are loaded. The filler fluid may be less dense than the aqueous phase such that the aqueous phase sinks in the wells. Alternatively the aqueous phase may sit above the filler fluid, in which case all the filler fluid must be withdrawn from the wells in order to enable entry of the aqueous fluid.

Where multiple volumes of reagents are to be loaded, the liquid is generally moved by extracting the filler fluid. Some or all of the aqueous reagent is introduced from each well to which an aqueous reagent has been added. As each of the wells contains the filler fluid, an even pressure is maintained as the filler fluid is withdrawn. Once all of the aqueous reagent has been draw into the device, the filler fluid located above the device can enter, thereby preventing any air being drawn into the device. In the absence of the filler fluid in the inlet ports, either a large amount of aqueous liquid is needed in order to fill the ports, or the ports with the lowest volumes of aqueous reagent added allow air to enter the device once all the aqueous liquid has been drawn it.

The device may be connected to a pump, for example a syringe pump, a peristaltic pump, a disc pump, a diaphragm pump, or a pneumatic pump. The pump enables filling of the device with filler liquid in an automated manner. Once filled, the pump enables partial withdrawal of the filler fluid to create a negative pressure in the device which draws in reagents from the wells. Thus the filling and withdrawal of fluid may be performed in an automated manner to allow largely ‘hands-free’ loading of the aqueous reagents. An automated filler liquid filling and withdrawal method may be integrated into an instrument that provides other functions relating to the digital microfluidic device, including heating, cooling, optical, sensing, mechanical, and magnetic functions.

The inlets may be at 90 degrees to each other. The inlets may be at 180 degrees to each other. The inlets may be on 4 sides of the device. Each side may have at least 4, 8 or 12 ports. Each side may have 8 ports. The device may have 4 sets of 8 ports. The number of ports may vary on different sides of the device, for example one side may have 8 ports and one side 4 ports. The device may have 8 ports on 3 sides and 16 ports on a fourth side. The device may have 8 ports on 2 sides and 16 ports on 2 sides. The device may have 8 ports on 1 side and 16 ports on 3 sides. The device may have 16 ports on 4 sides. The ports may be offset to give multiple rows of linear ports on one side, for example a first and second row where the second row is behind by offset from the first row such that the source liquid can flow between the ports of the first row. The rows may be a zig-zag fashion. Multiple volumes can be loaded from opposing faces. For example at least 32 volumes of aqueous liquid having at least 2 different volumes can be formed. At least 8 volumes from 4 opposing faces can be loaded simultaneously.

The device can be loaded evenly from multiple sides by withdrawing the filler fluid. The device can be loaded from 4 sides. The filler fluid can be extracted from one or more corners of the cell gap. The filler fluid can be extracted from the cell gap through two ports at different corners of the device using an automated syringe pump.

The ports may be located in a housing, for example a plastic housing adjacent to entry holes into the cell gap. The pitch between inlet ports may be 9 mm. The pitch between inlet ports may be 4.5 mm. The inlet ports have a pitch of 4.5 mm or a multiple of thereof. This would cover 24 well, 48 well, 96 well, 384 well ports. The pitch of the ports may be the same on each side of the device, or may be different sized. In this context the pitch refers to the distance between the centre of each inlet.

The volume of aqueous reagents loaded per inlet port may be between 1 microlitre and 50 microlitres. The volume may be between 1 microlitre and 20 microlitres. Different volumes can be loaded from each port.

The device and reagents can be used for protein expression. Thus the reagents loaded from a first side may contain reagents for expressing a protein, which may be cell-free protein synthesis reagents. The reagents loaded from a second side may contain nucleic acid templates, which may be linear or circular templates. The reagents introduced from the first side may be merged with the reagents introduced from the second side. The merged reagents may enable protein production. The reagents from a third side may allow may allow detection or purification of the expressed proteins. Reagents may also include for example additives enabling post-translational modification.

The aqueous liquid may be introduced to the wells by a pipette, a multichannel pipette, a syringe, a blister pack, an acoustic dispenser, or a robotic liquid handler. The aqueous liquids may be loaded simultaneously from multiple wells, which may be on the same side or multiple sides of the devices. Each well is a separate liquid, and can be the same or different to the contents of the aqueous volume in other wells. The volume of aqueous liquid loaded in each port can be the same or can be different.

The automated filling and/or withdrawing of filler fluid may be controlled by software. The device may be part of a larger instrument system that provides environmental control such as temperature control or light control and may have analytical capabilities such as optical systems for fluorescence or luminescence assay detection.

The location of the aqueous layer is controlled by the actuation of electrodes to form reservoirs in defined areas. A plurality of electrodes is actuated to control the location of the aqueous liquid once it has been drawn onto the substrate bearing a plurality of electrodes. Multiple reservoirs may be formed on the device. The reservoirs may contain a different volume of liquid, controlled by the number of electrodes actuated.

The device can be used for biological assays or the synthesis of biopolymers. The aqueous liquids loaded may be selected from for example cell-free protein synthesis reagents, solutions of nucleic acid constructs, solutions of detector proteins, slurries of magnetic or superparamagnetic beads, buffered solutions with a pH range of 6-8, wash solutions, solutions of recombinant proteins, solutions of small molecules with a molecular weight between 200 and 1000 g/mol.

The device may be used for cell-free protein synthesis. The cell-free protein synthesis reagent may be derived from an organism or formed from recombinant protein elements. The cell-free protein synthesis reagents may be a cell lysate or may be prepared from purified proteins. The cell-free protein synthesis reagents may be a blend of cell lysate and purified proteins. The cell-free protein synthesis reagents may be derived from a prokaryotic, mammalian, plant, or insect organism, for example E. coli, H. sapiens, C. griseus, N. tabacum, or T. aestivum.

Each well may have one or more entry holes. Each well may have a single entry hole onto the substrate. The entry holes may be between 0.2 millimeters and 2 millimeters in diameter. The entry holes may be 1 millimeter in diameter.

The method allows loading of the device without introduction of air bubbles, and without the need for a positive external pressure. The substrate remains covered by fluid at all times during loading. The filling and/or removal of the filler fluid may be performed at a rate of between 0.02 mL/minute and 2 mL/minute. The filling may be performed at between 0.5 and 1 ml/minute. The withdrawal may be performed at between 0.05 mL/minute and 0.1 mL/minute.

Each reservoir may comprise X by Y pixels where X is the width ranging from 10-50 pixels and Y is the length ranging from 10-150 pixels. The reservoirs may be different sizes depending on the required volume to be further dispensed from the reservoir. Different sized reservoirs may be formed simultaneously, for example 8 or more at a time. Reagents loaded into each port can enter the device by removing a portion of the filler fluid. The time saving in loading for example 40 reservoirs in one automated operation rather than consecutively is therefore substantial.

The time to load with manual method (pipetting) is related to the volume being loaded and the EW force. For loading multiple reservoir takes for example 30-50 mins (user related time) while automated syringe pump is ^{˜}8 mins and requires no user liquid handling after the wells are loaded.

The method can be applied to loading a reservoir. By introducing virtual calibration structures on the interstitial reservoirs of the device, a visual signal is produced which assists in the accurate loading of the reservoir with a defined area of liquid. These calibration structures are formed during the loading cycle of reagents and merged into the reservoirs during the dispense cycling. In effect the calibration structures are temporarily actuated electrodes on the far side of the reservoir electrodes from the fluid inlet. Once these temporally transient areas are filled, the electrodes forming the calibration structures are switched off and the liquid joins the main reservoir. This visual signal may be automatically detected by computer vision software to enable fully automated accurate loading.

Disclosed herein is a method for dynamically controlling the shape of aqueous phase for the controlled filling of a reservoir on a planar electrowetting on dielectric (EWoD) device, the method comprising:
a. providing a device with a plurality of wells connected via entry holes to a substrate bearing a plurality of electrodes;
b. filling the device with an aqueous immiscible filler liquid such that the plurality of wells are at least partially filled with the filler liquid;
c. loading one or more of the wells with an aqueous liquid which descends in the wells;
d. withdrawing a portion of the filler liquid from the device, thereby drawing the aqueous liquid onto the plurality of electrodes through the entry holes;
e. actuating reservoir electrodes to form a defined reservoir of aqueous liquid on the device; and
f. temporarily actuating electrodes on an opposing side of the reservoir to the source aqueous liquid to form one or more virtual calibration structures which are the last areas to fill, such that when the temporarily actuated electrodes are switched off the liquid becomes part of the reservoir, thereby accurately controlling the liquid area in the reservoir.

The virtual calibration structures can be elongated protrusions. There can be more than one elongated protrusions per reservoir. There can be two or three elongated protrusions per reservoir. Each of the elongated protrusions may comprise 1 to 10% of the area of the reservoir.

An opposing side may be at 90 degrees or 180 degrees in relation to the source of the flowing liquid entering the reservoir. The virtual calibration structures may be on more than one opposing side from the reservoir entry.

### BRIEF DESCRIPTION OF THE DRAWINGS

FIG. 1 shows an image of aqueous fluid being loading into a digital microfluidic device seated in an instrument. The aqueous fluid loading is facilitated by the presence of an automated syringe pump that can add or remove filler fluid at programmably defined flow rates.

FIG. 2 shows an image of a digital microfluidic device having a plurality of aqueous reservoirs loaded. Two sides (right; bottom) of the device are loaded with 8 reservoirs each, a third side (top) is loaded with 16 reservoirs, and a fourth side (left) is loaded with 4 reservoirs. Each reservoir can be different sizes and dimensions, controlled by the volume of aqueous fluid loaded into each well and the electrode pattern actuated on the array.

FIG. 3 shows the digital microfluidic device described in FIG. 3 in the process of being loaded with aqueous fluid. Once all the aqueous fluids have been loaded into appropriate wells and the withdrawal of filler fluid begins, the loading happens simultaneously from each side of the device.

FIG. 4 shows a sequence of images (1-3) demonstrating formation of eight aqueous reservoirs with calibration structures, driven with an air displacement multichannel pipette. The arrows show the formation of calibration structures on the reservoirs. The volume of the aqueous phase loaded is 5 μL, including both the reservoir to be formed and the calibration structures. The sizes of the actuated areas are 30×28 pixels for the main reservoir and 6×6 pixels for each of the calibration structures. The time required to fill the reservoirs was 120 seconds. The aqueous reagent loaded is 0.05% w/w Pluronic F127 in an aqueous buffer with red food colouring to aid visualisation (1:1 dilution). The filler fluid in the device is 0.1% span85 in dodecamethylpentasiloxane (DMPS). Image (4) shows a snapshot of the electrical actuation pattern sent to the electrodes on the device during reservoir filling, where white represents electrodes with a potential applied. The calibration structures are shown by the arrow on the image. FIG. 4 image (1) shows a DMF device primed with filler fluid. FIG. 4 image (2) shows the initial stages of reservoir loading. FIG. 4 image (3) shows two reservoirs filled to the correct volume (both calibration structures visible) while other reservoirs are still in the process of forming on the device.

FIG. 5a shows a diagrammatic figure of the loading process (shown for a single port). The device is made from a bottom plate having an array of electrodes (TFT), a top plate (optionally glass although may be plastic) defining a cell gap therebetween. The top glass contains holes for loading reagents. The top glass holes are located underneath a plastic housing containing inlet loading ports to load regents into the cell gap. (A) A device is filled with filler fluid to fill the cell gap and at least partially fill all the inlet ports. (B) Reagents are placed into the ports using an external source, for example a multi-channel pipette (one channel shown). (C) The reagent sinks to the bottom end of the port, close to the entry hole in the top glass. (D) Filler fluid is removed from the cell gap and the reagent is introduced into the device for downstream operations.

FIG. 5b shows a diagrammatic figure of a device, with one port connected to the filler fluid withdrawing unit and ports available for loading aqueous reagent. The loading process can be driven by removing filler fluid from one port or multiple ports. The multiple ports can be placed on the same side or on opposite sides on the device. The oil can be extracted from two corners of the device which can be on the same side or diagonal corners.

FIG. 6 shows port geometry to improve loading consistency. The lower figure shows an improved design with to inflections in the side walls. In the upper design the aqueous reagent can be trapped on the more horizontal regions of the walls, which can act as shelves preventing ingress of the aqueous reagents and increasing the intake of bubbles.

FIG. 7 shows loading of varying volumes into multiple different reservoirs. The larger reservoirs are 12 μl and the smaller 3 μl. The loading happened simultaneously as filler fluid is withdrawn. The figure shows the loading in progress.

FIG. 8 shows the activation pattern for loading FIG. 7.

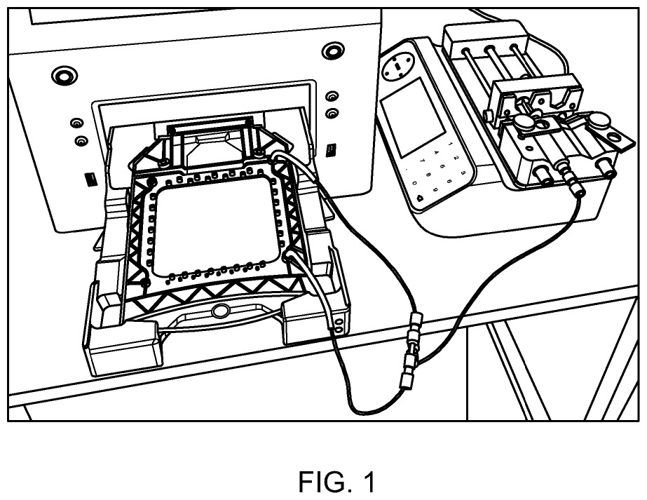

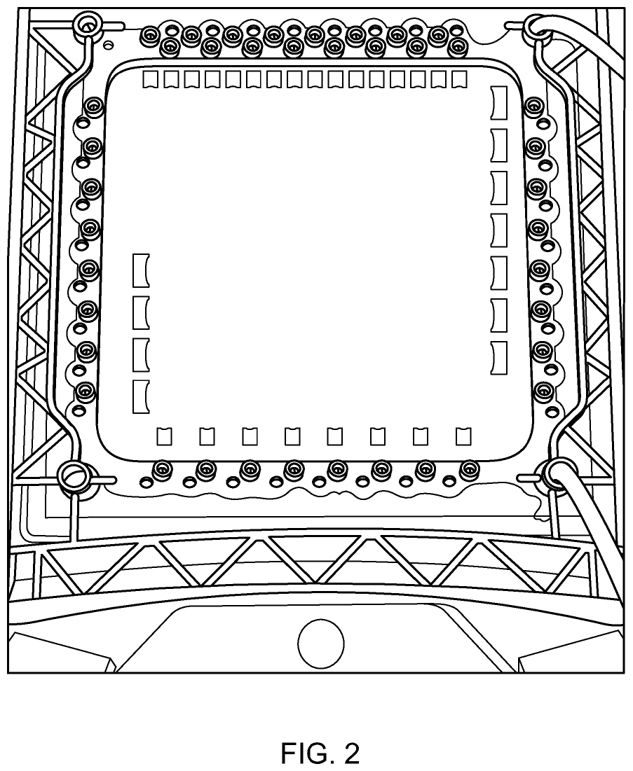

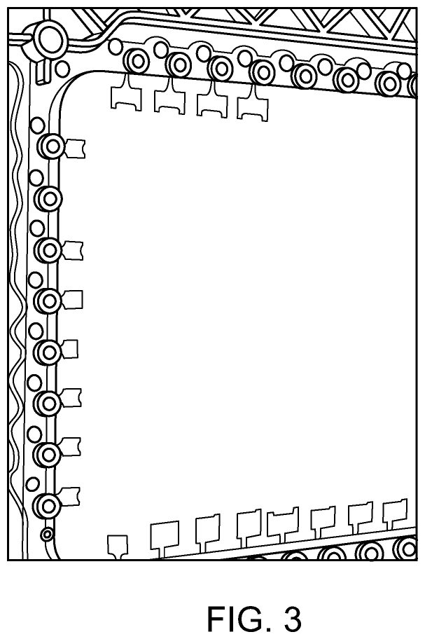

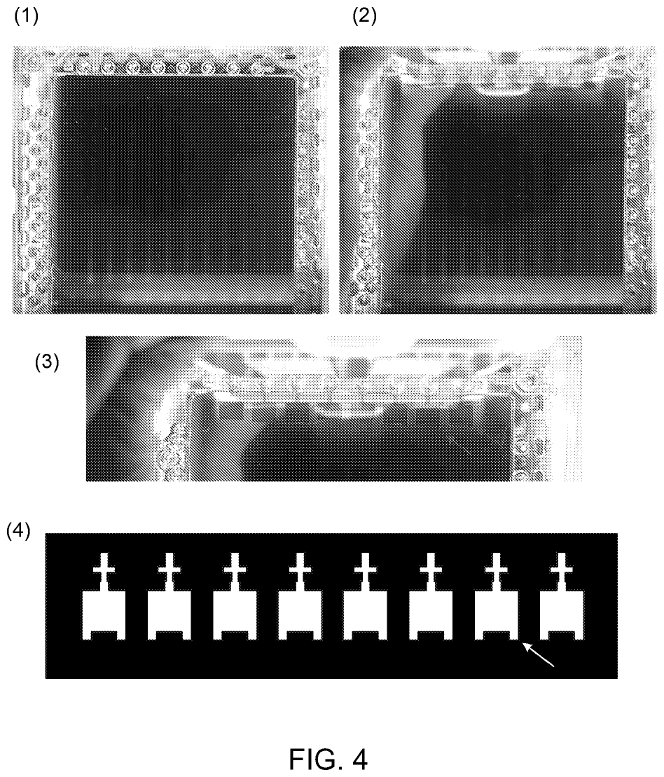

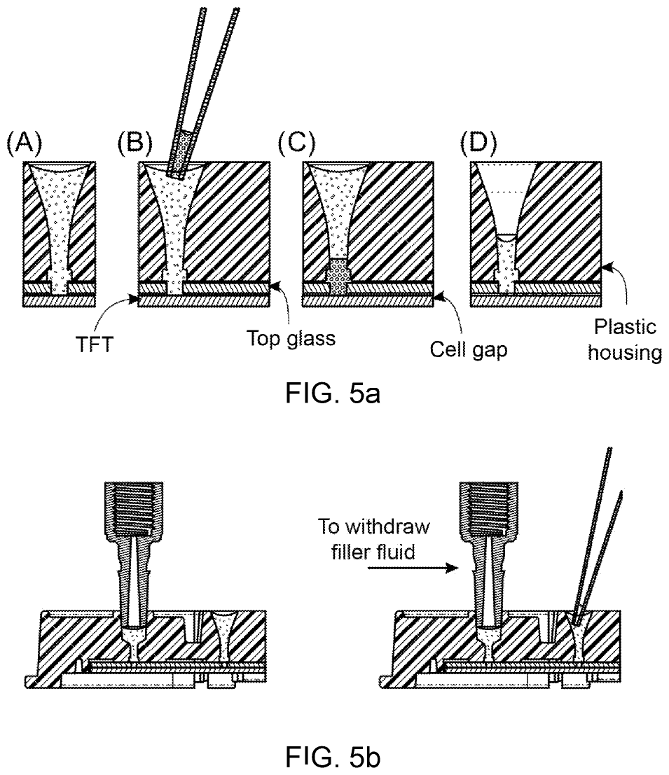

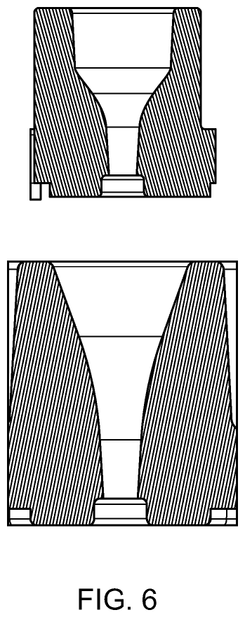

### DETAILED DESCRIPTION OF THE INVENTION

Disclosed is a method of loading aqueous liquid into a digital microfluidic device having a substrate bearing a plurality of electrodes by withdrawing a filler fluid in order to create a negative pressure which pulls the aqueous liquid onto the device. The negative pressure allows bubble free loading and loading without having to apply a positive pressure from an external source, which often results in leaking or ejection from the device once the positive pressure is released.

Disclosed is a method of loading aqueous liquid into a digital microfluidic device having a substrate bearing a plurality of electrodes, the method comprising:
a. providing a device with a plurality of wells connected via entry holes to a substrate bearing a plurality of electrodes;
b. filling the device with an aqueous immiscible filler liquid such that the plurality of wells are at least partially filled with the filler liquid;
c. loading one or more of the wells with an aqueous liquid; and
d. withdrawing a portion of the filler liquid from the device, thereby drawing the aqueous liquid onto the plurality of electrodes through the entry holes.

Disclosed is a method of loading aqueous liquid into a digital microfluidic device having a substrate bearing a plurality of electrodes, the method comprising:
a. providing a device with a plurality of wells connected via entry holes to a substrate bearing a plurality of electrodes;
b. filling the device with an aqueous immiscible filler liquid such that the plurality of wells are at least partially filled with the filler liquid;
c. loading one or more of the wells with an aqueous liquid which descends in the wells; and
d. withdrawing a portion of the filler liquid from the device, thereby drawing the aqueous liquid onto the plurality of electrodes through the entry holes.

Disclosed is a method of loading multiple differently sized volumes of aqueous liquid into a digital microfluidic device having a substrate bearing a plurality of electrodes, the method comprising:
a. providing a device with a plurality of wells connected via entry holes to a substrate bearing a plurality of electrodes;
b. filling the device with an aqueous immiscible filler liquid such that the plurality of wells are at least partially filled with the filler liquid;
c. loading two or more of the wells with an aqueous liquid which descends in the wells; and
d. withdrawing a portion of the filler liquid from the device, thereby drawing the aqueous liquids onto the plurality of electrodes through the entry holes in order to form multiple differently sized volumes of aqueous liquid.

Disclosed herein is a method for dynamically controlling the shape of aqueous phase for the controlled filling of a reservoir on a planar electrowetting on dielectric (EWoD) device, the method comprising:
a. providing a device with a plurality of wells connected via entry holes to a substrate bearing a plurality of electrodes;
b. filling the device with an aqueous immiscible filler liquid such that the plurality of wells are at least partially filled with the filler liquid;
c. loading one or more of the wells with an aqueous liquid which descends in the wells; and
d. withdrawing a portion of the filler liquid from the device, thereby drawing the aqueous liquid onto the plurality of electrodes through the entry holes;
e. actuating reservoir electrodes to form a defined reservoir of aqueous liquid on the device; and
f. temporarily actuating electrodes on an opposing side of the reservoir to the source aqueous liquid to form one or more virtual calibration structures which are the last areas to fill, such that when the temporarily actuated electrodes are switched off the liquid becomes part of the reservoir, thereby accurately controlling the liquid area in the reservoir.

The aqueous liquid may come from an external source via a pipette, a multichannel pipette, a syringe, a blister pack, an acoustic dispenser, or a robotic liquid handler.

The automated filling and/or withdrawing of filler fluid may be controlled by software. The device may be part of a larger system that provides environmental control such as temperature control, light control and may have analytical capabilities such as optical systems for fluorescence or luminescence assay detection.

The formation of one or more virtual calibration structures allows for more accurate filling of the reservoir, therefore resulting in a more standardised size of droplets being dispensed from the reservoirs on the EWoD device. These calibration structures are elongated protrusions (“fork-like” structures) from the reservoir of the EWoD device which are the last areas to be filled by the external reagent source.

The virtual calibration structures are formed by actuating electrodes on the device and the internal liquid is held in place by electrode actuation to form elongated protrusions. The number of electrodes activated to form the width of the calibration structures is less than the width of the defined reservoir. The number of electrodes activated to form the width of the calibration structures can be less than half the number forming the width of the defined reservoir.

The entry of the liquid can be via the top or side of the digital microfluidic array. The top entry point may be via a hole in the planar surface. The side entry may be via a gap in the adhesive holding the two planar surfaces together or via a gap in the spacer material defining the cell gap. The inlet port can be formed by a hole in the upper surface or side of the planar EWoD device. The hole can be approximately 1 mm in diameter.

The array of electrodes can be formed on the opposing surface of the planar EWoD device to the surface having the entry hole.

The external source can take the form of a pipette or delivery tube. The pipette may be mechanical or electronic. The pipette may be single-channel or multi-channel. A multi-channel pipette may have 8-channels or 12-channels. Disclosed herein is a method of loading an EWoD device using a multichannel pipette, for example a pipette having 4, 8 or 12 channels.

The pitch between inlet ports may be 9 mm. The pitch between inlet ports may be 4.5 mm. The inlet ports have a pitch of 4.5 mm or a multiple of thereof. This would cover 24 well, 48 well, 96 well, 384 well ports. The pitch of the ports may be the same on each side of the device, or may be different sized. In this context the pitch refers to the distance between the centre of each inlet.

The inlets may be in the top plate of the DMF device. The ports may be holes in the side of the fluidic gap of the DMF device.

The inlets can be tapered in order to prevent the loading process from damaging the electrodes on the device via physical contact. For example where a multichannel pipette is placed in the inlet ports, the tapering prevents contacts between the ends of the pipette tips and the surface of the device.

The inlets can be angled in order to prevent the loading process from damaging the electrodes on the device via physical contact. For example where a multichannel pipette is placed in the inlet ports, the angle prevents contacts between the ends of the pipette tips and the surface of the device. The angle is with respect to the array of electrodes, and is such that the entry is not 90° (vertical) in relation to the array (horizontal). As the loaded liquid sinks in the wells, there is no need to the loading device to actually contact the inlet ports. The wells contain the filler fluid, and the heavier aqueous liquid added sinks in the wells.

Disclosed herein is the use of a multichannel pipette to load a DMF device. The multichannel pipette may be mechanical, electronic or attached to a liquid handling robot arm. The multichannel pipette may have 4, 8 or 12 channels. The multichannel pipette may be positive displacement pipette, an air displacement pipette, or a liquid displacement pipette.

Disclosed herein is the use of non-contact acoustic handling dispensing devices to load ports of a DMF device.

The volume of reagents loaded per inlet port may be between 1 microlitre and 50 microlitres. The volume may be between 1 microlitre and 20 microlitres.

The electrode actuation to form temporal loading protrusions can occur for a period of greater than 1 second. The electrode actuation can occur for a period of 10-120 seconds.

Fluidic introduction to the reservoir can be improved using a virtual delivery path using temporary electrode actuation to form a temporary hydrophilic path across the otherwise hydrophobic surface. The path can form a temporal flow path between the inlet and the actuated reservoir using electrode actuation whilst the reagents are being delivered to the reservoir. The temporary delivery path can be formed by actuating greater than 2 electrodes. The delivery path can be formed by actuating between 10-500 electrodes arranged in an elongated pattern. The delivery path can formed by actuating electrodes arranged in an elongated pattern of 35 long by 8 wide. The delivery path can formed by actuating electrodes arranged in an elongated pattern of 22 electrodes long by 4 electrodes wide. The pattern can be 22-35 electrodes long and 4-8 wide.

The on-chip reservoir can be formed 2-500 electrodes away from the inlet port. The on-chip reservoir can be formed with 0.1 to 100 μL. Multiple on-chip reservoirs can be formed using a single inlet port. Alternatively multiple inlet ports can be used to combine reagents into one or more on-chip reservoirs.

The droplet release from the reservoir can be performed using any means of electrokinesis. The droplet can be moved using electrowetting-on-dielectric (EWoD). The electrical signal on the EWoD or optical EWoD device can be delivered through segmented electrodes, active-matrix thin-film transistors, or digital micromirrors.

The term digital microfluidic (DMF) device refers to a device having a two-dimensional array of planar microelectrodes. The term excludes any devices simply having droplets in a flow of oil in a channel. The droplets are moved over the surface by electrokinetic forces by activation of particular electrodes. Upon activation of the electrodes the dielectric layer becomes less hydrophobic, thus causing the droplet to spread onto the surface. A digital microfluidic device set-up is known in the art, and depends on the substrates used, the electrodes, the configuration of those electrodes, the use of a dielectric material, the thickness of that dielectric material, the hydrophobic layers, and the applied voltage.

An electrokinetic device includes a first substrate having a matrix of electrodes, wherein each of the matrix electrodes is coupled to a thin film transistor, and wherein the matrix electrodes are overcoated with a functional coating comprising: a dielectric layer in contact with the matrix electrodes, a conformal layer in contact with the dielectric layer, and a hydrophobic layer in contact with the conformal layer; a second substrate comprising a top electrode; a spacer disposed between the first substrate and the second substrate and defining an electrokinetic workspace; and a voltage source operatively coupled to the matrix electrodes.

The dielectric layer may comprise silicon dioxide, silicon oxynitride, silicon nitride, hafnium oxide, yttrium oxide, lanthanum oxide, titanium dioxide, aluminum oxide, tantalum oxide, hafnium silicate, zirconium oxide, zirconium silicate, barium titanate, lead zirconate titanate, strontium titanate, or barium strontium titanate. The dielectric layer may be between 10 nm and 100 μm thick. Combinations of more than one material may be used, and the dielectric layer may comprise more than one sublayer that may be of different materials.

The conformal layer may comprise a parylene, a siloxane, or an epoxy. It may be a thin protective parylene coating in between the insulating dielectric and the hydrophobic coating. Typically, parylene is used as a dielectric layer on simple devices. In this invention, the rationale for deposition of parylene is not to improve insulation/dielectric properties such as reduction in pinholes, but rather to act as a conformal layer between the dielectric and hydrophobic layers. The inventors find that parylene, as opposed to other similar insulating coatings of the same thickness such as PDMS (polydimethylsiloxane), prevent contact angle hysteresis caused by high conductivity solutions or solutions deviating from neutral pH for extended hours. The conformal layer may be between 10 nm and 100 μm thick.

The hydrophobic layer may comprise a fluoropolymer coating, fluorinated silane coating, manganese oxide polystyrene nanocomposite, zinc oxide polystyrene nanocomposite, precipitated calcium carbonate, carbon nanotube structure, silica nanocoating, or slippery liquid-infused porous coating.

The elements may comprise one or more of a plurality of array elements, each element containing an element circuit; discrete electrodes; a thin film semiconductor in which the electrical properties can be modulated by incident light; and a thin film photoconductor whose properties can be modulated by incident light.

The functional coating may include a dielectric layer comprising silicon nitride, a conformal layer comprising parylene, and a hydrophobic layer comprising an amorphous fluoropolymer. This has been found to be a particularly advantageous combination.

The electrokinetic device may include a controller to regulate a voltage provided to the individual matrix electrodes. The electrokinetic device may include a plurality of scan lines and a plurality of gate lines, wherein each of the thin film transistors is coupled to a scan line and a gate line, and the plurality of gate lines are operatively connected to the controller. This allows all the individual elements to be individually controlled.

### Devices

The manipulation of droplets by the application of electrical potential can be achieved on electrodes covered with an insulator or a dielectric or a series of insulators or dielectrics. Droplet manipulation as a result of an applied electrical potential is known as electrowetting. Electrokinesis occurs as result of a non-uniform electric field that influences the hydrostatic equilibrium of a dielectric liquid (dielectrophoresis or DEP) or a change in the contact angle of the liquid on solid surface (electrowetting-on-dielectric or EWoD). DEP can also be used to create forces on polarizable particles to induce their movement. The electrical signal can be transmitted to a discrete electrode, a transistor, an array of transistors, or a sheet of semi-conductor film whose electrical properties can be modulated by an optical signal.

EWoD phenomena occur when droplets are actuated between two parallel electrodes covered with a hydrophobic insulator or dielectric. The electric field at the electrode-electrolyte interface induces a change in the surface tension, which results in droplet motion as a result of a change in droplet contact angle. The electrowetting effect can be quantitatively treated using Young-Lippmann equation:

$$cos θ - cos {θ}_{0} = \{ 1 / 2 γ LG ) c . {V}^{2}$$

where θ₀ is the contact angle when the electric field across the interfacial layer is zero, γ_{LG} is the liquid-gas tension, c is the specific capacitance (given as εᵣ, ε₀/t, where εᵣ is dielectric constant of the insulator/dielectric, so is permittivity of vacuum, t is thickness) and V is the applied voltage or electrical potential. The change in contact angle (inducing droplet movement) is thus a function of surface tension, electrical potential, dielectric thickness, and dielectric constant.

When a droplet is actuated by EWoD, there are two opposing sets of forces that act upon it: an electrowetting force induced by electric field and resistant forces that include the drag forces resulting from the interaction of the droplet with filler medium and the contact line friction. The minimum voltage applied to balance the electrowetting force with the sum of all drag forces (threshold voltage) is variably determined by the thickness-to-dielectric contact ratio of the insulator/dielectric, (t/Σᵣ)^{1/2}. Thus, to reduce actuation voltage, it is required to reduce (t/εᵣ)^{1/2} (i.e., increase dielectric constant or decrease insulator/dielectric thickness). To achieve low voltage actuation, thin insulator/dielectric layers must be used. However, the deposition of high quality thin insulator/dielectric layers is a technical challenge, and these thin layers are easily damaged before the desired electrowetting contact angle is large enough to drive the droplet is achieved. Most academic studies thus report the use of much higher voltages >100V on easily fabricated, thick dielectric films (>3 μm) to effect electrowetting.

High voltage EWoD-based devices with thick dielectric films, however, have limited industrial applicability largely due to their limited droplet multiplexing capability. The use of low voltage devices including thin-film transistors (TFT) and optically-activated amorphous silicon layers (a-Si) have paved the way for the industrial adoption of EWoD-based devices due to their greater flexibility in addressing electrical signals in a highly multiplex fashion. The driving voltage for TFTs or optically-activated a-Si are low (typically <15 V). The bottleneck for fabrication and thus adoption of low voltage devices has been the technical challenge of depositing high quality, thin film insulators/dielectrics. Hence there has been a particular need for improving the fabrication and composition of thin film insulator/dielectric devices.

Typically, the electrodes (or the array elements) used for EWoD are covered with (i) a hydrophilic insulator/dielectric and a hydrophobic coating or (ii) a hydrophobic insulator/dielectric. Commonly used hydrophobic coatings comprise of fluoropolymers such as Teflon AF 1600 or CYTOP. The thickness of this material as a hydrophobic coating on the dielectric is typically <100 nm and can have defects in the form of pinholes or a porous structure; hence, it is particularly important that the insulator/dielectric is pinhole free to avoid electrical shorting. Teflon™ has also been used as an insulator/dielectric, but it has higher voltage requirements due to its low dielectric constant and the thickness required to make it pinhole free. Other hydrophobic insulator/dielectric materials can include polymer-based dielectrics such as those based on siloxane, epoxy (e.g. SU-8), or parylene (e.g., parylene N, parylene C, parylene D, or parylene HT). Due to minimal contact angle hysteresis and a higher contact angle with aqueous solutions, Teflon™ is still used as a hydrophobic topcoat on these insulator/dielectric polymers. However, there are difficulties in reliably producing <1 micron pinhole-free coatings of parylene or SU-8; thus, the thickness of these materials is typically kept at a 2-5 microns at the cost of increased voltage requirements for electrowetting. It has also been reported that traditional EWoD devices with parylene C are easily broken and unstable for repeated droplet manipulation with cell culture medium.

Multi-layer insulator devices deposited with metal-oxide and parylene C films have been used to produce a more robust insulator/dielectric and enable operations with lower applied voltages. Inorganic materials, such metal oxides and semiconductor oxides, commonly used in the CMOS industry as “gate dielectrics”, have been used as insulator/dielectric for EWoD devices. They offer the advantage of utilizing standard cleanroom processes for thin film depositions (<100 nm). These materials are inherently hydrophilic, requiring an additional hydrophobic coating, and can be prone to pinhole formation as a result of thin film layer deposition process. Together with the need for lower voltage operations of EWoD, recent developmental work has focused on (1) using materials with improved dielectric properties (e.g., using high-dielectric constant insulators/dielectrics), (2) optimizing the fabrication process to make the insulator/dielectric pinhole free to avoid dielectric breakdown.

The devices can be used for any biochemical assay process involving high solute (ionic) strength solutions where the high concentration of ions would otherwise degrade and prevent use of prior art devices. The devices are particularly advantageous for processes involving the synthesis of biomolecules such as for example nucleic acid synthesis, for example using template independent strand extensions, or cell-free protein expression using a population of different nucleic acid templates.

Disclosed is an active-matrix thin film transistor (AM-TFT) device having a substrate bearing a plurality of electrodes, the device comprising multiple fluidic inlet ports on at least two sides of the device, wherein the inlet ports on each side of the device are evenly spaced and wherein the device is connected to a pump. The device may comprise two substrates, wherein at least one substrate has a plurality of electrodes, and the two substrates define parallel plates that are separated by a spacer to define a volume.

The device may be connected to a pump, for example a syringe pump, a peristaltic pump, a disc pump, a diaphragm pump, or a pneumatic pump. The pump enables filling of the device with filler fluid in an automated manner. Once filled, the pump enables withdrawal of the filler fluid to create a negative pressure in the device which sucks in reagents from the wells. Thus the withdrawal of fluid may be performed in an automated manner to allow ‘hands-free’ loading of the aqueous reagents.

### Applications of the Invention

The invention can be used in a myriad of different applications. In these applications the steps of disposing an aqueous droplet having an ionic strength on a first matrix electrode and providing a differential electrical potential may be repeated many times. They may be repeated over 1000 times or over 10,000 times, sometimes over a 24 hour period.

### Enzymatic DNA Synthesis Applications

The present method can be used in the synthesis of nucleic acids, such as phosphoramidite-based nucleic acid synthesis, templated or non-templated enzymatic nucleic acid synthesis, or more specifically, terminal deoxynucleotidyl transferase (TdT) mediated addition of 3′-O-reversibly terminated nucleoside 5′-triphosphates to the 3′-end of 5′-immobilized nucleic acids. During enzymatic nucleic acid synthesis, the following steps are taken on the instrument:
I. Addition solution containing TdT, optionally pyrophosphatase (PPiase), 3′-O-reversibly terminated dNTPs, and required buffer (including salts and necessary reaction components such as metal divalents) is brought to a reaction zone containing an immobilized nucleic acid, where the nucleic acid is immobilized on a surface such as through magnetic beads via a covalent linkage to the 5′ terminus of the nucleic acid. The initial immobilized nucleic acid may be known as an initiator oligonucleotides and comprises N nucleotides, for example 3-100 nucleotides, preferably 10-80 nucleotides, and more preferably 20-65 nucleotides. Initiator oligonucleotides may contain a cleavage site, such as a restriction site or a non-canonical DNA base such as U or 8-oxoG. Addition solution may optionally contain a phosphate sensor, such as E. coli phosphate-binding protein conjugated to MDCC fluorophore, to assess the quality of nucleic acid synthesis as a fluorescent output. dNTPs can be combined in ratios to make DNA libraries, such as NNK syntheses.
II. Wash solution, either in bulk or in discrete droplets, is applied to reaction zones to wash away the addition solution. Wash solution typically has a high solute concentration (>1 M NaCl).
III. Deprotection solution, either in bulk or in discrete droplets, is applied to reaction zones to deprotect the 3′-O-reversible terminator added to the immobilized nucleic acids in the immobilized nucleic acid zone in step I. Deprotection solution typically has a high solute concentration.
IV. Wash solution, either in bulk or in discrete droplets, is applied to reaction zones to wash away the deprotection solution.
V. Steps I-IV are repeated until desired sequences are synthesized, for example steps I-IV are repeated 10, 50, 100, 200 or 1000 times.

The present method can be used in the preparation of oligonucleotide sequences, either via synthesis or assembly. The device allows synthesis and movement of defined sequences. Using the present method the initiation sequences can be modified at a specific location above an electrode and the extended oligonucleotides prepared. The initiation sequences at different locations can be exposed to different nucleotides, thereby synthesising different sequences in different regions of the electrowetting device.

After synthesis of a defined population of different sequences in different regions of the electrowetting device, the sequences can be further assembled in longer contiguous sequences by joining two or more synthesised strands together.

Described herein is a method for preparing a contiguous oligonucleotide sequence of at least 2n bases in length comprising taking the electrowetting device as described herein having a plurality of immobilised initiation oligonucleotide sequences, one or more of which contains a cleavage site, using the initiation oligonucleotide sequences to synthesise a plurality of immobilised oligonucleotide sequences of at least n bases in length, using cycles of extension of reversibly blocked nucleotide monomers, selectively cleaving at least two of the immobilised oligonucleotide sequences of least n bases in length into a reaction solution whilst leaving one or more of the immobilised oligonucleotide sequences attached, hybridizing at least two of the cleaved oligonucleotides to each other, to form a splint, and hybridizing one end of the splint to one of the immobilized oligonucleotide sequences and joining at least one of the cleaved oligonucleotides to the immobilised oligonucleotide sequences, thereby preparing a contiguous oligonucleotide sequence of at least 2n bases in length.

The present invention can be used to automate the movements of droplets in a cartridge. For example, droplets intended for analysis can be moved according to the present invention. The present invention could be incorporated into a cartridge used for local clinician diagnostics. For example it could be used in conjunction with nucleic acid amplification testing (NAAT) to determine nucleic acid targets in, for example, genetic testing for indications such as cancer biomarkers, pathogen testing for example detecting bacteria in a blood sample or virus detection, such as a coronavirus, e.g. SARS-COV-2 for the diagnosis of COVID-19.

The device may be thermocycled to enable nucleic acid amplification, or the device may be held at a desired temperature for isothermal amplification. Having different sequences synthesised in different regions of the device allows multiplex amplification using different primers in different regions of the device.

Furthermore the invention can be used in conjunction with next generation sequencing in which DNA is synthesised by the addition of nucleotides and large numbers of samples are sequenced in parallel. The present invention can be used to accurately locate the individual samples used in next generation sequencing.

The invention can be used to automate library preparation for next generation sequencing. For example the steps of ligation of sequencing adaptors can be carried out on the device. Amplification of a selective subset of sequences from a sample can then have adaptors attached to enable sequencing of the amplified population.

### Protein Expression Applications

The method of moving aqueous droplets may also be used to help facilitate cell-free expression of peptides or proteins. In particular, droplets containing a nucleic acid template and a cell-free system having components for protein expression in an oil-filled environment can be moved using a method of the invention in the described electrokinetic device.

Disclosed herein is a method for the real-time monitoring of in-vitro protein synthesis comprising
a. In-vitro transcription and translation of a protein of interest fused to a peptide tag; and
b. monitoring the presence of the peptide tag using a further polypeptide which in the presence of the peptide tag produces a detectable signal.

Disclosed herein is a method for the monitoring of cell-free protein synthesis in a droplet on a digital microfluidic device comprising
a. cell-free transcription and translation of a protein of interest fused to a peptide tag; and
b. monitoring the presence of the peptide tag using a further polypeptide which in the presence of the peptide tag produces a detectable signal.

The use of the terms “in-vitro” and “cell-free” may be used interchangeably herein.

The detectable signal may be for example fluorescence or luminescence. The detectable signal may also be caused by the binding of a ligand to the complemented oligopeptide, peptide, or polypeptide tag fused to the protein of interest.

The detectable signal may also be caused by the binding of the polypeptide to the protein of interest fused to a His-tag.

Any in-vitro transcription and translation may be used, for example extract-based systems derived from rabbit reticulocyte lysate, human lysate, Chinese Hamster Ovary lysate, a wheat germ, HEK293 lysate, E. coli lysate, yeast lysate.

Alternatively the in-vitro transcription and translation may be assembled from purified components, for example a system of purified recombinant elements (PURE).

The in-vitro transcription and translation may be coupled or uncoupled.

The peptide tag may be one component of a fluorescent protein and the further polypeptide a complementary portion of the fluorescent protein. The fluorescent protein could include sfGFP, GFP, ccGFP, eGFP, deGFP, frGFP, eYFP, eBFP, eCFP, Citrine, Venus, Cerulean, Dronpa, DsRED, mKate, mCherry, mRFP, FAST, SmURFP, miRFP670nano. For example the peptide tag may be GFP₁₁ and the further polypeptide GFP₁₋₁₀. The peptide tag may be one component of sfCherry. The peptide tag may be sfCherry₁₁ and the further polypeptide sfCherry₁₋₁₀. The peptide tag may be CFAST₁₁ or CFAST₁₀ and the further polypeptide NFAST in the presence of a hydroxybenzylidene rhodanine analog.

The peptide tag may also be one component of a protein that forms a detectable substrate, such as a luminescent or colorigenic substrate. The protein could include beta-galactosidase, beta-lactamase, or luciferase.

The protein may be fused to multiple tags. For example the protein may be fused to multiple GFP₁₁ peptide tags and the synthesis occurs in the presence of multiple GFP₁₋₁₀ polypeptides. For example the protein may be fused to multiple sfCherry₁₁ peptide tags and the synthesis occurs in the presence of multiple sfCherry₁₋₁₀ polypeptides. The protein of interest may be fused to one or more sfCherry₁₁ peptide tags and one or more GFP₁₁ peptide tags and the synthesis occurs in the presence of one or more GFP₁₋₁₀ polypeptides and one or more sfCherry₁₋₁₀ polypeptides.

Any protein of interest may be synthesised. The protein may be an enzyme, for example a terminal deoxynucleotidyl transferase (TdT) enzyme or a truncated version thereof or the homologous amino acid sequence of a terminal deoxynucleotidyl transferase (TdT) enzyme in other species or the homologous amino acid sequence of Polu, PolB, PolA, and Pole of any species or the homologous amino acid sequence of X family polymerases of any species.

Protein expression typically requires an ample supply of oxygen. The most convenient and high yielding way to power CFPS is via oxidative phosphorylation where O₂ serves as the final electron acceptor; however, there are other ways that involve replenishing with energy molecules not involved in oxidative phosphorylation. In a confined microfluidic or digital microfluidic system of droplets, insufficient oxygen is available to enable efficient protein synthesis.

Described herein are improved methods allowing for the cell-free expression of peptides or proteins in a digital microfluidic device. Included is a method for the cell-free expression of peptides or proteins in a microfluidic device wherein the method comprises one or more droplets containing a nucleic acid template (i.e., DNA or RNA) and a cell-free system having components for protein expression in an oil-filled environment, and moving said droplets using electrowetting. The components for the cell-free protein synthesis droplet can be pre-mixed prior to introduction to or mixed on the digital microfluidic device.

The droplet can be repeatedly moved for at least a period of 30 minutes whilst the protein is expressed. The droplet can be repeatedly moved for at least a period of two hours whilst the protein is expressed. The droplet can be repeatedly moved for at least a period of twelve hours whilst the protein is expressed. The act of moving the droplet allows oxygen to be supplied to the droplet and dispersed throughout the droplet. The act of moving improves the level of protein expression over a droplet which remains static.

The droplet can be moved using any means of electrowetting. The droplet can be moved using electrowetting-on-dielectric (EWoD). The electrical signal on the EWoD or optical EWoD device can be delivered through segmented electrodes, active-matrix thin-film transistors, or digital micromirrors.

The filler fluid in the device can be any water immiscible liquid. The filler fluid can be mineral oil, silicone oil such as dodecamethylpentasiloxane (DMPS), an alkyl-based solvent such as decane or dodecane, or a fluorinated oil. The filler fluid can be oxygenated prior to or during the expression process.

A source of supplemental oxygen can be supplied to the droplets. For example droplets or gas bubbles containing gaseous or dissolved oxygen can be merged with the droplets during the protein expression. Additionally, a source of supplemental oxygen can be found by oxygenating the oil that is used as the filler medium. It is well-known in the art that oils such as hexadecane, HFE-7500, and others can be oxygenated to support the oxygen requirements of cell growth, especially E. coli cell growth (RSC Adv., 2017, 7, 40990-40995). Oxygenation can be achieved by aerating the oil with pure oxygen or atmospheric air.

The droplets can be formed before entering the microfluidic device and flowed into the device. Alternatively the droplets can be merged on the device. Included is a method comprising merging a first droplet containing a nucleic acid template such as a plasmid with a second droplet containing a cell-free extract having the components for protein expression to form a combined droplet capable of cell-free protein synthesis.

The droplets can be split on the device either before or after expression. Included herein is a method further comprising splitting the aqueous droplet into multiple droplets. If desired the split droplets can be screened with further additives. Included is a method wherein one or more of the split droplets are merged with additive droplets for screening.

The cell-free expression of peptides or proteins can use a cell lysate having the reagents to enable protein expression. Common components of a cell-free reaction include an energy source, a supply of amino acids, cofactors such as magnesium, and the relevant enzymes. A cell extract is obtained by lysing the cell of interest and removing the cell walls, DNA genome, and other debris by centrifugation. The remains are the cell machinery including ribosomes, aminoacyl-tRNA synthetases, translation initiation and elongation factors, nucleases, etc. Once a suitable nucleic acid template is added, the nucleic acid template can be expressed as a peptide or protein using the cell derived expression machinery.

Any particular nucleic acid template can be expressed using the system described herein. Three types of nucleic acid templates used in CFPS include plasmids, linear expression templates (LETs), and mRNA. Plasmids are circular templates, which can be produced either in cells or synthetically. LETs can be made via PCR. While LETs are easier and faster to make, plasmid yields are usually higher in CFPS. mRNA can be produced through in-vitro transcription systems. The methods use a single nucleic acid template per droplet. The methods can use multiple droplets having a different nucleic acid template per droplet.

An energy source is an important part of a cell-free reaction. Usually, a separate mixture containing the needed energy source, along with a supply of amino acids, is added to the extract for the reaction. Common sources are phosphoenolpyruvate, acetyl phosphate, and creatine phosphate. The energy source can be replenished during the expression process by adding further reagents to the droplet during the process.

The cell-free extract having the components for protein expression includes everything required for protein expression apart from the nucleic acid template. Thus the term includes all the relevant ribosomes, enzymes, initiation factors, nucleotide monomers, amino acid monomers, metal ions and energy sources. Once the nucleic acid template is added, protein expression is initiated without further reagents being required.

Thus the cell-lysate can be supplemented with additional reagents prior to the template being added. The cell-free extract having the components for protein expression would typically be produced as a bulk reagent or ‘master mix’ which can be formulated into many identical droplets prior to the distinct template being separately added to separate droplets. Common cell extracts in use today are made from E. coli (ECE), rabbit reticulocytes (RRL), wheat germ (WGE), insect cells (ICE) and Yeast Kluyveromyces (the D2P system). All of these extracts are commercially available.

Rather than originating from a cell extract, the cell-free system can be assembled from the required reagents. Systems based on reconstituted, purified molecular reagents are commercially available, for example the PURE system for protein production, and can be used as supplied. The PURE system is composed of all the enzymes that are involved in transcription and translation, as well as highly purified 70S ribosomes. The protein synthesis reaction of the PURE system lacks proteases and ribonucleases, which are often present as undesired molecules in cell extracts.

Once the CFPS reagents have been enclosed in the droplets, additional reagents can be supplied by merging the original droplet with a second droplet. The second droplet can carry any desired additional reagents, including for example oxygen or ‘power’ sources, or test reagents to which it is desired to expose to the expressed protein.

The droplets can be aqueous droplets. The droplets can contain an oil immiscible organic solvent such as for example DMSO. The droplets can be a mixture of water and solvent, providing the droplets do not dissolve into the bulk filler liquid.

The droplets containing the cell-free extract having the components for protein expression will therefore typically be in the oil filled environment before the nucleic acid templates are added to the droplets. The templates can be added by merging droplets on the microfluidic device. Alternatively, the templates can be added to the droplets outside the device and then flowed into the device for the expression process. For example the expression process can be initiated on the device by increasing the temperature. The expression system typically operates optimally at temperatures above standard room temperatures, for example at or above 29° C.

The expression process typically takes many hours. Thus the process should be left for at least 30 minutes or 1 hour, typically at least 2 hours. Expression can be left for at least 12 hours. During the process of expression the droplets should be moved within the device. The moving improves the process by mixing the reagents and ensuring sufficient oxygen is available within the droplet. The moving can be continuous, or can be repeated with intervening periods of non-movement.

Thus the aqueous droplet can be repeatedly moved for at least a period of 30 minutes or one hour whilst the protein is expressed. The aqueous droplet can be repeatedly moved for at least a period of two hours whilst the protein is expressed. The aqueous droplet can be repeatedly moved for at least a period of twelve hours whilst the protein is expressed. The act of moving the droplet allows mixing within the droplet, and allows oxygen or other reagents to be supplied to the droplet. The act of moving improves the level of protein expression over a droplet which remains static.

Through an affinity tag, such as a FLAG-tag, HIS-tag, GST-tag, MBP-tag, STREP-tag, or other form of affinity tag, CFPS-expressed proteins can be immobilized to a solid-support affinity resin and fresh batches of CFPS reagent can be delivered over the said resin. Thus, renewed reagents can be used to carry out protein synthesis, closely mimicking industrial methods of continuous flow (CF) and continuous exchange (CE) CFPS. By mimicking CF- and CE-CFPS, users can scale up their CFPS production methods.

Droplets can also contain additives to reduce the effects of biofouling on digital microfluidic surfaces. Specifically, droplets containing CFPS components can also contain additives such as surfactants or detergents to reduce the effects of biofouling on the hydrophobic or superhydrophobic surface of a digital microfluidic device (Langmuir 2011, 27, 13, 8586-8594). Such droplets may use antifouling additives such as TWEEN 20, Triton X-100, and/or Pluronic F127. Specifically, droplets containing CFPS components may contain TWEEN 20 at 0.1% v/v, Triton X-100 at 0.1% v/v, and/or Pluronic F127 at 0.08% w/v.

Rather than adding surfactants to the aqueous sample, it is instead possible to add surfactant, such as a sorbitan ester such as Span85 (e.g. Sorbitan trioleate, Sigma Aldrich, SKU 8401240025), to the filler liquid. This has the advantages of enabling CFPS reactions to proceed on-DMF without dilution or adulteration. Additionally, it simplifies the sample preparation procedure for setting up the reactions, increasing the ease of use and the consistency of results. Using 1% w/w Span85 in dodecane allows for dilution-free CFPS reactions on-DMF, as well as dilution-free detection of the expressed non-fluorescent proteins. Other surfactants besides Span85, and oils other than dodecane could be used. A range of concentrations of Span85 could be used. Surfactants could be nonionic, anionic, cationic, amphoteric or a mixture thereof. Oils could be mineral oils or synthetic oils, including silicone oils, petroleum oils, and perfluorinated oils. Surfactants can have a detrimental effect on (1) the CFPS reactions and (2) the efficiency of the detection system (if the detection system involves complementation of a tag and detector). For example, by performing the CFPS reaction on-DMF with oil-surfactant mix, the detection of the expressed protein can also proceed without dilution and without adding aqueous surfactant. It has been shown that surfactants reduce the efficiency of some detection systems, including but not limited to the Split GFP (e.g. GFP11/GFP1-10) system, so removing surfactants from the reagent mix and instead adding them to the oil can be beneficial.

The peptide tag can be attached to the C or N terminus of the protein. The peptide tag may be one component of a green fluorescent protein (GFP). For example the peptide tag may be GFP₁₁ and the further polypeptide GFP₁₋₁₀. The peptide tag may be one component of sfCherry. The peptide tag may be sfCherry₁₁ and the further polypeptide sfCherry₁₋₁₀.

The protein may be fused to multiple tags. For example the protein may be fused to multiple GFP₁₁ peptide tags and the synthesis occurs in the presence of multiple GFP₁₋₁₀ polypeptides. For example the protein may be fused to multiple sfCherry₁₁ peptide tags and the synthesis occurs in the presence of multiple sfCherry₁₋₁₀ polypeptides. The protein of interest may be fused to one or more sfCherry₁₁ peptide tags and one or more GFP₁₁ peptide tags and the synthesis occurs in the presence of one or more GFP₁₋₁₀ polypeptides and one or more sfCherry₁₋₁₀ polypeptides.

Where used herein “and/or” is to be taken as specific disclosure of each of the two specified features or components with or without the other. For example “A and/or B” is to be taken as specific disclosure of each of (i) A, (ii) B and (iii) A and B, just as if each is set out individually herein. Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

### Example Loading Protocol:

Step 1—Priming a Digital Microfluidic Device with an Aqueous Immiscible Filler Fluid

1.5 mL of dodecamethylpentasiloxane (DMPS) with 0.1% v/v Span85 (Filler fluid) was introduced to a digital microfluidic device at a flow rate of 1 mL/min via an automated syringe pump (Chemyx Fusion 200X). After waiting for a period of 30 seconds which allows the filler fluid to level in all of the loading wells, an additional 0.5 ml of filler fluid is introduced at 0.5 ml/min. This resulted in the digital microfluidic device together with all of the loading wells to be primed with filler fluid.

Step 2—Transferring the Aqueous Reagents into Loading Ports

An 8-channel multichannel pipette was used to load 3-12 μL of aqueous reagent into separate wells. Depending on the reservoir required, poets were loaded with 3 μl in some ports, 5 μl in some ports and 12 μl in some ports.

Step 3—Withdrawal of Filler Fluid to Facilitate Entry of Aqueous Reagents into the Digital Microfluidic Device

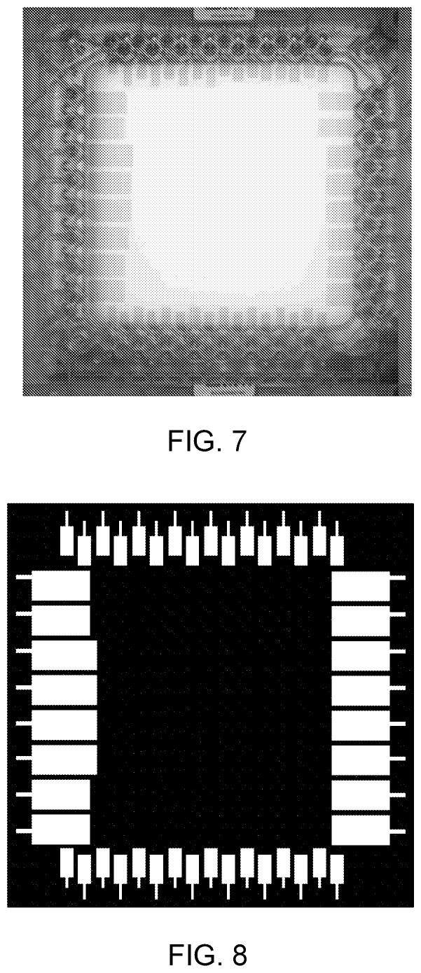

0.7 mL of filler fluid was withdrawn from the digital microfluidic device using the same syringe pump at a flow rate of 0.1 ml/min. At the end of this step, the aqueous reagents had entered the digital microfluidic device, contacted the electrode substrate, and thus been formed into reservoirs by electrode activation. The loading in process can be seen in FIG. 7.

1. Disclosed is a method of loading multiple differently sized volumes of aqueous liquid into a digital microfluidic device having a substrate bearing a plurality of electrodes, the method comprising:
a. providing a device with a plurality of wells connected via entry holes to a substrate bearing a plurality of electrodes;
b. filling the device with an aqueous immiscible filler liquid such that the plurality of wells are at least partially filled with the filler liquid;
c. loading two or more of the wells with an aqueous liquid which descends in the wells; and
d. withdrawing a portion of the filler liquid from the device, thereby drawing the aqueous liquids onto the plurality of electrodes through the entry holes in order to form multiple differently sized volumes of aqueous liquid.

2. The method of claim 1, wherein the digital microfluidic device is an active-matrix thin film transistor (AM-TFT) based device.

3. The method according to claim 1 or claim 2, wherein at least 8 reservoirs of aqueous liquid are formed simultaneously on the device.

4. The method according to any one of claims 1-3, wherein the device is loaded simultaneously from two or more sides of the device where different volumes are loaded from each side.

5. The method of any one of claims 1-4, wherein the digital microfluidic device comprises two parallel plates that are separated by a spacer to define a fluid volume.

6. The method of any one of claims 1-5, wherein the filler liquid is a hydrophobic or non-ionic liquid.

7. The method of any one of claims 1-6, wherein the entry holes are in a top substrate and the plurality of electrodes are on a bottom substrate.

8. The method of claim 5, wherein the spacer comprises an adhesive with beads of a defined size distribution, glass or a polymer material of a defined thickness.

9. The method of any one of claims 5-8, wherein the spacer defines a gap of between 50 microns and 250 microns.

10. The method of any one of claims 1-9, wherein the filler liquid is drawn from the device by a syringe pump, a peristaltic pump, a disc pump, a diaphragm pump, or a pneumatic pump.

11. The method of any one of claims 1-10, wherein the aqueous liquid is introduced to the wells by a pipette, a multichannel pipette, a syringe, a blister pack, an acoustic dispenser, or a robotic liquid handler.

12. The method of any one of claims 1-11, wherein a subset of the plurality of electrodes is actuated to control the location of the aqueous liquid once it has been drawn onto the substrate bearing a plurality of electrodes.

13. The method of any one of claims 1-12, wherein the entry holes are between 0.2 millimeters and 2 millimeters in diameter, for example 1 millimeter in diameter.

14. The method of any one of claims 1-13, wherein each well has a single entry hole.

15. The method of any one of claims 1-14, wherein the filling is performed at between 0.01 and 2 mL/minute.

16. The method of any one of claims 1-15, wherein the removal is performed at between 0.01 mL/minute and 2 mL/minute.

17. The method of any one of claims 1-16, wherein the aqueous fluid introduced to the device forms an aqueous reservoir and comprises temporarily actuating electrodes on an opposing side of the reservoir to the source liquid to form one or more virtual calibration structures which are the last areas to fill and once filled indicate a precise volume of aqueous fluid has been introduced, such that when the temporarily actuated electrodes are switched off the liquid becomes part of the reservoir, thereby accurately controlling the liquid area in the reservoir.

18. The method according to any one of claims 1-17, wherein the reservoir comprises X by Y pixels where X is the width ranging from 10-50 pixels and Y is the length ranging from 10-150 pixels.

19. The method according to any one preceding claim, wherein the aqueous reagent being loaded into the device contains a DNA construct and/or reagents for cell-free protein synthesis.

20. The method according to any of claims 1-19, wherein the filler liquid is dodecamethylpentasiloxane, decane or docecane.

21. The method according to any of claims 1-20, wherein the filler liquid contains a surfactant.

22. The method according to claim 21, wherein the surfactant is a sorbitan ester.

23. The method according to any one preceding claim, wherein at least 32 volumes of aqueous liquid are formed having at least 2 different sizes.

24. The method according to any one preceding claim wherein the sides of the wells are shaped to form a continuous curve having no inflection points.

25. The method according to any one preceding claim wherein the filler fluid is withdrawn through two ports at different corners of the device using an automated syringe pump.
